(19) United States
(12) Patent Application Publication
(10) Pub. No.: US 2007/0003799 A1
(43) Pub. Date: Jan. 4, 2007

(54) Magnetic recording medium and magnetic recording/reproducing apparatus

(75) Inventors: Hideo Ogiwara, Tachikawa-shi (JP); Tsutomu Tanaka, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/477,561

(22) Filed: Jun. 30, 2006

(30) Foreign Application Priority Data
Jun. 30, 2005 (JP) 2005-191207

(51) Int. Cl. G11B 5/706

(52) U.S. Cl. 428/848.1; 428/848.2

(57) ABSTRACT

Letting Ra1 be the average surface roughness of the inner peripheral surface of a data region, and Ra2 be the average surface roughness of the outer peripheral surface of the data region, a magnetic recording medium uses a disk-like substrate having a relationship represented by 0<Ra1−Ra2≦0.2 nm.

### CROSS-REFERENCE TO RELATED APPLICATIONS

This application is based upon and claims the benefit of priority from Japanese Patent Application No. 2005-191207, filed Jun. 30, 2005, the entire contents of which are incorporated herein by reference.

### BACKGROUND

1. Field

The present invention relates to a magnetic recording medium for use in, e.g., a hard disk drive using the magnetic recording technique, and a magnetic recording/reproducing apparatus using the same.

2. Description of the Related Art

With the recent increase in computer processing speed, a magnetic storage device such as HDD for storing and reproducing information is being required to have high speed and high density.

As the recording density increases, the floating degree of a recording/reproducing head with respect to a magnetic disk decreases. To decrease the floating degree, the glide of a medium must be lowered. For this purpose, the medium surface is often smoothed by decreasing its roughness Ra. The smaller the surface roughness Ra of the medium, the more favorable the pressure reduction characteristics of a floating head. However, if the roughness is too small, the head is readily attracted to the medium. Important parameters of the pressure reduction characteristics of the floating head are not only a so-called touchdown characteristic by which the head comes into contact with the medium when the rotational speed or pressure is decreased, but also a so-called takeoff characteristic by which the head floats from the contact state and returns to a stable state as the rotational speed or pressure is increased.

For example, for a contact start/stop magnetic disk for which a magnetic head is held in a non-data zone on the magnetic disk when it is not rotated, the pressure reduction characteristics can be improved by making the average surface roughness of the data zone surface on the inner periphery of the disk larger than that on the outer periphery of the disk, as described in Jpn. UM. Appln. KOKAI Publication No. 3-49620.

Unfortunately, the linear velocity decreases toward the inner periphery more on a magnetic disk having a small diameter, particularly, a diameter of 1 inch or less, than on a magnetic disk having a diameter of 2.5 inches. Since this decreases the floating pressure, the floating stability of a head lowers to make it more attractable. Therefore, the pressure reduction characteristics must be further improved.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is schematic view showing the sectional structure of an example of a magnetic recording medium of the present invention;

FIG. 2 is a graph showing the surface roughness of a substrate used in the magnetic recording medium shown in FIG. 1; and

FIG. 3 is a perspective view showing the arrangement of an example of a magnetic recording/reproducing apparatus of the present invention.

### DETAILED DESCRIPTION

Various embodiments according to the invention will be described hereinafter with reference to the accompanying drawings. In general, according to one embodiment of the invention, a magnetic recording medium of the present invention comprises a disk-like substrate and a magnetic recording layer formed on the substrate, wherein the disk-like substrate has a diameter of 1 inch or less, and, letting Ra1 be the average surface roughness of the inner peripheral surface of a data region, and Ra2 be the average surface roughness of the outer peripheral surface of the data region, has a relationship represented by 0<Ra1−Ra≦0.2 nm.

A magnetic recording/reproducing apparatus of the present invention comprises a magnetic recording medium having a disk-like substrate and a magnetic recording layer formed on the substrate, and a recording/reproducing head, wherein the disk-like substrate used has a diameter of 1 inch or less, and, letting Ra1 be the average surface roughness of the inner peripheral surface of a data region, and Ra2 be the average surface roughness of the outer peripheral surface of the data region, has a relationship represented by 0<Ra1−Ra2≦0.2 nm.

In the present invention, the disk-like substrate on which the surface roughness of the inner peripheral surface is larger than that of the outer peripheral surface is used. Therefore, the surface shape of the magnetic recording layer formed on this disk-like substrate has substantially the same surface roughness as the substrate surface. When this surface roughness is given to the medium surface, a head is not easily attracted to the medium, so a pressure reduction margin can be increased. Accordingly, even in a magnetic recording medium having a diameter of, e.g., 1 inch or less, the pressure reduction characteristics such as the touchdown characteristic and takeoff characteristic improve. When the floating height is decreased, therefore, it is possible to suppress attraction of the magnetic recording layer surface, which readily occurs particularly on the inner periphery.

As described above, the use of the present invention makes it possible to control the floating of a head by the magnetic recording medium.

If the difference between the average surface roughness Ra1 and average surface roughness Ra2 is larger than 0.2 nm, the variation in roughness on the inner and outer peripheries increases, and this worsens the pressure reduction characteristics on the inner periphery.

In one embodiment of the present invention, letting Ra3 be an arbitrary average surface roughness of a surface intermediate between the inner peripheral surface and outer peripheral surface of the disk-like substrate, the average surface roughness Ra1 of the inner peripheral surface, the average surface roughness Ra2 of the outer peripheral surface, and the intermediate average surface roughness Ra3 have a relationship represented by Ra1>Ra3≧Ra2.

In some embodiment of the present invention, the surface roughness of the disk-like substrate can be increased step by step in the circumferential direction from the outer peripheral surface to the inner peripheral surface.

If a portion having an average surface roughness larger than the average surface roughness Ra1 of the inner peripheral surface and the average surface roughness Ra2 of the outer peripheral surface exists between them, the pressure reduction characteristics often worsen in this portion.

In addition, in one embodiment of the present invention, the average surface roughness Ra1 of the inner peripheral surface of the disk-like substrate is 0.8 nm or less. If the average surface roughness Ra1 exceeds 0.8 nm, the floating of the head is adversely affected, and the pressure reduction characteristics often worsen.

The surface roughness of the disk-like substrate can be formed by, e.g., polishing, texture, and application of a liquid chemical.

As the liquid chemical, it is possible to use acids such as dilute sulfuric acid and hydrofluoric acid.

In one embodiment of the present invention, the average surface roughness of the whole substrate used in the present invention is 0.3 to 0.8 nm.

Also, this average surface roughness can be measured by surface observation by using, e.g., an e.g. atomic force microscope (AFM).

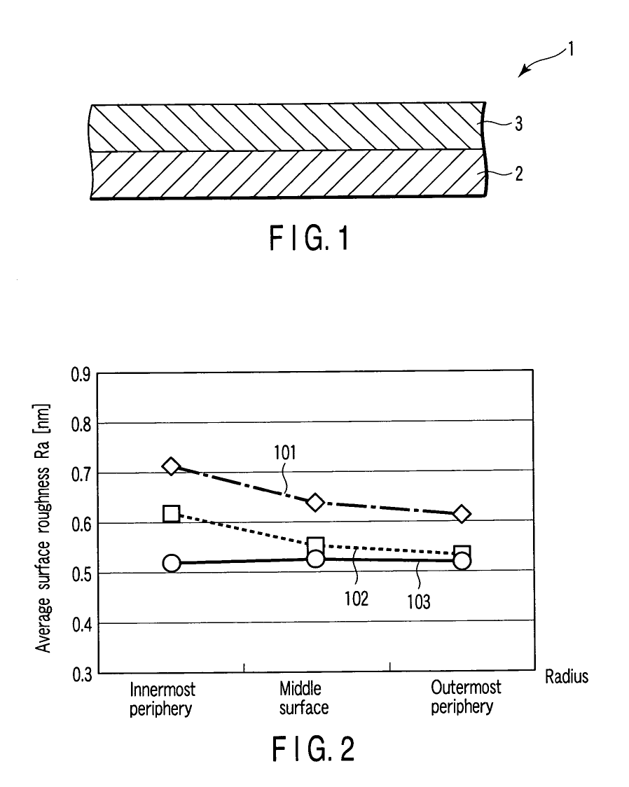

FIG. 1 is a schematic view showing the sectional structure of an example of the magnetic recording medium of the present invention.

As shown in FIG. 1, a magnetic recording medium 1 has a crystallized glass substrate 2 and magnetic recording layer 3. The substrate 2 has, e.g., an outer diameter of 21.6 mm, an inner diameter of 6 mm, and a thickness of 0.381 mm. The surface of the substrate 2 is processed by, e.g., mechanical texture such that the surface roughness has a relationship represented by Ra1>Ra3≧Ra2. The magnetic recording layer 3 is made of, e.g., CoCrPt, and formed on the substrate 2 by sputtering.

FIG. 2 is a graph showing the surface roughness of the substrate used in the magnetic recording medium shown in FIG. 1.

In FIG. 2, reference number 101 denotes the average surface roughness in the radial direction of the substrate used in the magnetic recording medium shown in FIG. 1. In this case, the average surface roughness Ra1 of the inner peripheral surface, the average surface roughness Ra2 of the outer peripheral surface, and the intermediate surface roughness Ra3 have a relationship represented by Ra1>Ra3≧Ra2.

Reference number 102 denotes the average surface roughness in the radial direction of a substrate used in another example of the magnetic recording medium of the present invention. In this case, the relationship is represented by Ra1>Ra3≅Ra2.

Furthermore, reference number 103 denotes the average surface roughness in the radial direction of a substrate used in a conventional magnetic recording medium. In this case, the average surface roughness Ra1 of the inner peripheral surface, the average surface roughness Ra2 of the outer peripheral surface, and the intermediate surface roughness Ra3 are substantially equal.

Note that each of the three substrates described above is made of crystallized glass, and has an outer diameter of 21.6 mm, an inner diameter of 6 mm, and a thickness of 0.381 mm.

In one embodiment of the present invention, the disk-like substrate used in the present invention can be selected from the group consisting of glass, aluminum, silicon, and plastic.

In some embodiment of the present invention, the disk-like substrate is, e.g., a glass substrate. Examples of this glass substrate are amorphous glass, reinforced glass, and crystallized glass.

In some embodiment of the present invention, amorphous glass or reinforced glass can be used. When crystallized glass is used, crystal grains produce slow undulation, and this prevents easy attraction. On the other hand, the touchdown characteristic worsens by the influence of the undulation.

As a method of forming the magnetic recording layer on the substrate, it is possible to use physical evaporation methods such as sputtering, vacuum evaporation, evaporation in gas, and gas flow sputtering.

As a seed layer and undercoating, Cr-based alloys are used most often. However, it is also possible to use, e.g., TiN, TiC, TiO, MgO, VN, VC, and ZrC each having an NaCl structure, and NiAl, FeAl, CsBr, CuPd, CsCl, CuZn, AgMg, and BeCu each having a CsCl structure.

As the material of the magnetic recording layer, it is possible to use a ferromagnetic material containing at least one type of element selected from, e.g., Co, Fe, and Ni. Examples of this ferromagnetic material are CoCrPt, CoCrTa, CoTaPt, CoNiTa, and CoPt.

As a protective film, diamond-like carbon, hydrogenated carbon, or the like formed by, e.g., CVD or sputtering is used.

When the magnetic recording medium is to be given an antiferromagnetic structure, it is also possible to form a staked structure of a magnetic film, e.g., stabilizing layer/Ru/magnetic film, e.g. magnetic recording layer on the undercoating.

In one embodiment of the present invention, in the magnetic recording medium of the present invention, the innermost periphery of the data region is separated by 4.0 to 4.7 mm from the center of the disk substrate. In some embodiment of the present invention, this disk substrate can be applied to a magnetic recording/reproducing apparatus having a ramped loading mechanism which holds a head in a position separated from the magnetic disk outer periphery. In addition, a non-data region on the inner periphery of the magnetic recording medium is small, so the medium can be further reduced in size.

The present invention is applicable to any of a perpendicular magnetic recording medium having an easy axis of magnetization in the perpendicular direction, a perpendicular magnetic recording/reproducing apparatus using the same, a longitudinal magnetic recording medium having an easy axis of magnetization in the longitudinal direction, and a longitudinal magnetic recording/reproducing apparatus using the same.

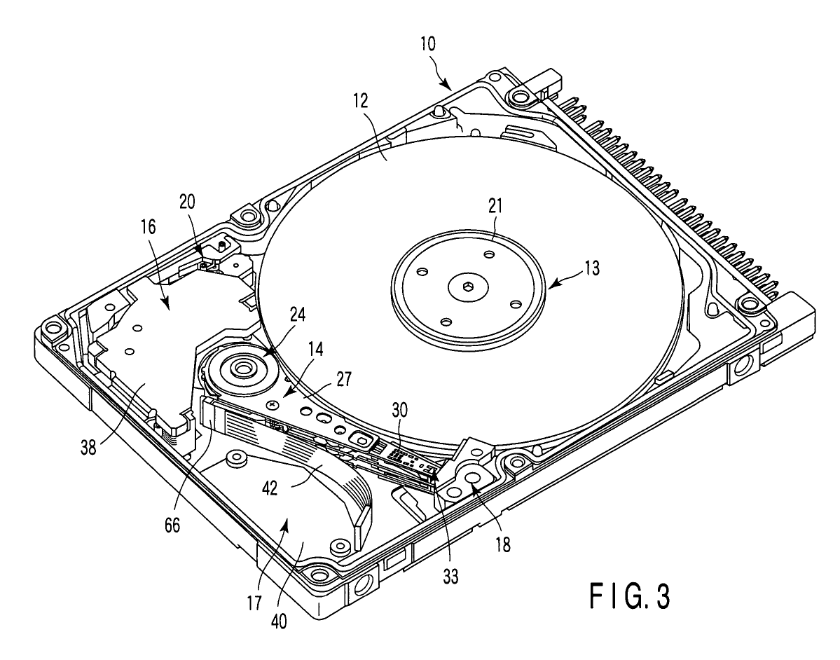

FIG. 3 is a perspective view showing the arrangement of an example of the magnetic recording/reproducing apparatus of the present invention.

As shown in FIG. 3, a hard disk drive referred to as an HDD hereinafter, as a disk device has a rectangular boxy case 10 having an open upper end, and a top cover (not shown) which is screwed to the case by a plurality of screws to close the upper-end opening of the case.

The case 10 contains a magnetic disk 12 as a recording medium, a spindle motor 13 which supports and rotates the magnetic disk 12, a magnetic head 33 which records information on and reproduces information from the magnetic disk, a head actuator 14 which movably supports the magnetic head 33 with respect to the magnetic disk 12, a voice coil motor 16 referred to as a VCM hereinafter, which rotates and positions the head actuator, a ramped loading mechanism 18 which holds the magnetic head 33 in a position separated from the magnetic disk when the magnetic head moves to the outermost periphery of the magnetic disk, an inertia latching mechanism 20 which holds the head actuator in a retracted position when an impact or the like acts on the HDD, and a flexible printed circuit board unit referred to as an FPC unit hereinafter, 17 on which electronic parts such as a preamplifier are mounted.

The spindle motor 13, VCM 16, and a printed circuit board not shown which controls the operation of the magnetic head are screwed to the outer surface of the case 10 via the FPC unit 17 so as to face the bottom wall of the case.

The magnetic disk 12 has a diameter of, e.g., 65 mm that is about 2.5 inches, and has a magnetic recording layer. The magnetic disk 12 is fitted on a hub not shown, of the spindle motor 13, and clamped by a clamp spring 21. The magnetic disk 12 is rotated at a predetermined speed by the spindle motor 13 as a driver.

The magnetic head 33 is a so-called combined head formed on a substantially rectangular slider not shown. The magnetic head 33 has a write head having a single pole structure, a read head using a GMR film or TMR film, and a (MR), e.g. magnetio-resistive head for recording and reproduction. The magnetic head 33 is fixed together with the slider to a gimbal unit formed on the distal end portion of a suspension 132.

### EXAMPLES

Samples 1 to 7 described below were formed.

Sample 1

First, a crystallized glass substrate having a longitudinal surface roughness distribution of 0.1 nm or less, an outer diameter of 21.6 mm, an inner diameter of 6 mm, and a thickness of 0.381 mm was formed as a comparative substrate.

Although chamfer polishing was performed on the inner and outer peripheries, it may also be omitted.

A CrTi seed layer, Cr alloy undercoating, CoCrPtB alloy magnetic layer, and carbon protective film were formed in this order on the substrate in a 0.27-Pa Ar ambient by sputtering, thereby obtaining a magnetic recording medium of sample 1.

Sample 2

When a crystallized glass substrate having an outer diameter of 21.6 mm and an inner diameter of 6 mm was polished to a thickness of 0.381 mm, the pressure and rotational speed of the whetstone and the grain size and concentration of the abrasive grains were changed to form a substrate on which the roughness continuously increased from the outer peripheral surface to the inner peripheral surface.

The average surface roughness was smallest on the outer peripheral surface and continuously increased toward the inner peripheral surface. The difference in average surface roughness between the outer peripheral surface and inner peripheral surface was about 0.1 to 0.2 nm. Also, the roughness on the outer peripheral surface was adjusted to about 4 nm. Note that the average surface roughness was obtained on the basis of the surface condition measured by using an atomic force microscope (AFM) manufactured by Digital Installment.

The obtained substrate was used to obtain a magnetic recording medium of sample 2 in the same manner as with sample 1.

Sample 3.

A substrate was formed following the same procedures as with sample 2 except that the average surface roughness was almost the same from the outer peripheral surface to a substantially middle surface in the radial direction and continuously increased from the middle surface to the inner peripheral surface. The difference in average surface roughness between the outer peripheral surface and inner peripheral surface was also about 0.1 to 0.2 nm. The roughness on the outer peripheral surface was adjusted to about 4 nm.

The obtained substrate was used to obtain a magnetic recording medium of sample 3 in the same manner as with sample 1.

Sample 4

A substrate similar to that of sample 1 was prepared. Diamond abrasive grains were mixed in a coolant, and the disk was sandwiched between cloth tapes while the abrasive grains were dropped, and textured in the circumferential direction by rotating it. During the texture, the disk was evenly textured by periodically swinging the tapes in the radial direction. Note that the texture was light texture with which the roughness distribution before the texture remained unchanged. The average surface roughness was smallest on the outer peripheral surface and continuously increased toward the inner peripheral surface. The difference in average surface roughness between the outer peripheral surface and inner peripheral surface was about 0.1 to 0.2 nm. The roughness on the outer peripheral surface was adjusted to about 4 nm.

The obtained substrate was used to obtain a magnetic recording medium of sample 4 in the same manner as with sample 1.

In addition, as an example using another method of changing the roughness, a substrate having a roughened surface was formed by etching the surface with a liquid chemical such as an acid or alkali. In this case, an amorphous substrate was used because if a crystallized substrate is used, the surface condition changes greatly owing to the difference between the etching rates of a crystal portion and non-crystal portion.

Sample 5

A glass substrate similar to that of sample 1 was prepared and dipped in an acid having an appropriate concentration, thereby forming a substrate having an average surface roughness which continuously increased in the radial direction from the outer peripheral surface to the inner peripheral surface as in sample 2. The average surface roughness was controlled by adjusting the concentration of the acid, the dipping time, and the dipping method. The difference in average surface roughness between the outer peripheral surface and inner peripheral surface of the obtained substrate was about 0.1 to 0.2 nm. The roughness on the outer peripheral surface was adjusted to about 4 nm.

The obtained substrate was used to obtain a magnetic recording medium of sample 5 in the same manner as with sample 1.

Sample 6

An amorphous substrate having a longitudinal surface roughness distribution of 0.1 nm or less, an outer diameter of 21.6 mm, an inner diameter of 6 mm, and a thickness of 0.381 mm was formed, and textured in the same manner as with sample 4. In this sample, however, the substrate was textured hard by increasing the pressing force or the like, thereby forming a substrate on which the average surface roughness continuously increased in the radial direction from the outer peripheral surface to the inner peripheral surface.

The average surface roughness was smallest on the outer peripheral surface and continuously increased toward the inner peripheral surface. The difference in average surface roughness between the outer peripheral surface and inner peripheral surface was about 0.1 to 0.2 nm. The roughness on the outer peripheral surface was adjusted to about 4 nm.

The obtained substrate was used to obtain a magnetic recording medium of sample 6 in the same manner as in sample 1.

Sample 7

Sample 7 was formed following the same procedures as in sample 6 except that the difference in average surface roughness between the outer peripheral surface and inner peripheral surface was about 0.3 nm.

When the glide of each sample was measured by a glide measurement device, all the measured glides were 5 nm or less.

The magnetic recording characteristic and electromagnetic conversion characteristic of each sample were checked. Table 1 shows the characteristics. The magnetic recording characteristic was measured with a vibrating sample magnetometer (VSM). The electromagnetic conversion characteristic was measured with a spinstand manufactured by Guzik by using a head used in an actual drive. The obtained results are shown in Table 1 below.

TABLE 1

| Sample | Hc | S/Nm (dB) |
|---|---|---|
| 1 | 335750 (A/m)(4250 Oe) | 24.2 |
| 2 | 334170 (A/m)(4230 Oe) | 23.7 |
| 3 | 335750 (A/m)(4250 Oe) | 23.9 |
| 4 | 342070 (A/m)(4330 Oe) | 25.1 |
| 5 | 340490 (A/m)(4310 Oe) | 25.3 |
| 6 | 347600 (A/m)(4400 Oe) | 25.5 |
| 7 | 346810 (A/m)(4390 Oe) | 25.4 |

Samples 1 to 7 were different only in substrate conditions, and all layers were formed on these substrates by the same method. However, a coercive force Hc slightly differed from one sample to another. This was probably caused by, e.g., the presence/absence of texture and the crystallinity of the magnetic recording layer. As the magnetic recording characteristic, the resolution of an anisotrophic medium such as sample 4 was higher than that of an isotropic medium such as sample 1. The electromagnetic conversion characteristics of anisotropic media were superior to those of isotropic media. Of these anisotropic media, a medium which was textured harder improved better.

To check the floating characteristic of a head with respect to each medium, the touchdown TD characteristic and takeoff TO characteristic were measured by using a head used in an actual magnetic recording/reproducing apparatus.

The touchdown TD characteristic is a pressure measured by an e.g. acoustic emission (AE) sensor attached to a head when the head which stably floats from a medium rotating at a predetermined rotational speed in a predetermined environment comes in contact with the medium when the pressure is reduced. The takeoff TO characteristic is a pressure measured when a head in contact with a medium rotating at a predetermined rotational speed in a predetermined environment floats by raising the pressure that means no signal is output from the AE sensor any longer.

In all the samples except for sample 6, the TD characteristic could be decreased to about 0.6 atm, and there was no big difference. The TD of sample 6 was 0.65 to 0.7 atm. The TD was worst, i.e., about 0.7 atm, on the innermost periphery. This is presumably because a high roughness on the inner peripheral surface decreased the floating marginches.

Also, the TD of sample 4 was higher by about 0.05 atm than those of the other samples. This is presumably because the surface shape largely changed since it was roughened by using a liquid chemical. In effect, the average surface roughness was equivalent to those of the other samples, but a maximum surface roughness Rp was higher by about 0.5 nm.

On the other hand, the TO characteristics were different between the substrates. The TO characteristic of sample 6 was favorable probably because the TD on the inner peripheral surface was bad. As the characteristics on the outer peripheral surfaces of the samples except for sample 6, the TO was substantially 0.6 to 0.65 atm in any sample, but the characteristics on the inner peripheral surfaces were different between the samples. The TD of sample 1 alone was bad, i.e., about 0.8 atm, on the inner peripheral surface. This is probably because a low surface roughness increased attraction, so once the head was brought into contact with the medium, attraction increased to make floating unstable.

In each of samples 2 to 7 except for sample 1, the TO characteristic on the inner peripheral surface was about 0.65 atm, and the difference between the TD characteristic and TO characteristic on the inner peripheral surface was substantially 0 to 0.05 atm, i.e., exhibited a very good value.

As described above, the floating characteristic, particularly, the TO characteristic on the inner peripheral surface can be improved by making the roughness on the inner peripheral surface lager than that on the outer peripheral surface. Furthermore, the roughness can be freely controlled by, e.g., the material, polishing method, or texture control method.

Although the examples using the glass substrates are explained above, a metal or plastic substrate such as Al or Si may also be used as the substrate material. In addition, the medium size is not limited to a 0.85-inch medium, and it is also possible to use a 1-inch medium, 0.85- and 1-inch media having different inner diameters, and a medium having no hole in its center. The magnetic recording characteristic and electromagnetic conversion characteristic of the magnetic recording medium formed on the substrate change in accordance with the magnetic recording layer itself, but the floating characteristic remains unchanged. Therefore, the present invention is similarly effective to a magnetic recording medium for perpendicular magnetic recording.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a disk-like substrate having a diameter of not more than 1 inch, and, letting Ra1 be an average surface roughness of an inner peripheral surface of a data region, and Ra2 be an average surface roughness of an outer peripheral surface of the data region, having a relationship represented by 0<Ra1−Ra2≦0.2 nm;
and a magnetic recording layer formed on the substrate.

2. A medium according to claim 1, wherein letting Ra3 be an intermediate average surface roughness between the inner peripheral surface and the outer peripheral surface, the average surface roughness Ra1 of the inner peripheral surface, the average surface roughness Ra2 of the outer peripheral surface, and the intermediate average surface roughness Ra3 have a relationship represented by Ra1>Ra3≧Ra2.

3. A medium according to claim 1, wherein the average surface roughness Ra1 of the inner peripheral surface is not more than 0.8 nm.

4. A medium according to claim 1, wherein a surface roughness of the disk-like substrate increases step by step from the outer peripheral surface to the inner peripheral surface of the data region.

5. A medium according to claim 1, wherein a surface roughness of the disk-like substrate is formed by polishing, texture, and application of a liquid chemical.

6. A medium according to claim 1, wherein the disk-like substrate is made of a material selected from the group consisting of glass, aluminum, silicon, and plastic.

7. A medium according to claim 1, wherein an innermost periphery of the data region is separated by 4.0 to 4.7 mm from a center.

8. A magnetic recording/reproducing apparatus comprising:
a magnetic recording medium having a disk-like substrate having a diameter of not more than 1 inch, and, letting Ra1 be an average surface roughness of an inner peripheral surface of a data region, and Ra2 be an average surface roughness of an outer peripheral surface of the data region, having a relationship represented by 0<Ra1−Ra2≧0.2 nm, and a magnetic recording layer formed on the substrate; and
a recording/reproducing head.

9. An apparatus according to claim 8, further comprising a ramped loading mechanism which holds the head in a position separated from a magnetic disk outer periphery.

10. An apparatus according to claim 8, wherein letting Ra3 be an intermediate average surface roughness between the inner peripheral surface and the outer peripheral surface, the average surface roughness Ra1 of the inner peripheral surface, the average surface roughness Ra2 of the outer peripheral surface, and the intermediate average surface roughness Ra3 have a relationship represented by Ra1>Ra3≧Ra2.

11. An apparatus according to claim 8, wherein the average surface roughness Ra1 of the inner peripheral surface is not more than 0.8 nm.

12. An apparatus according to claim 8, wherein a surface roughness of the disk-like substrate increases step by step from the outer peripheral surface to the inner peripheral surface of the data region.

13. An apparatus according to claim 8, wherein a surface roughness of the disk-like substrate is formed by polishing, texture, and application of a liquid chemical.

14. An apparatus according to claim 8, wherein the disk-like substrate is made of a material selected from the group consisting of glass, aluminum, silicon, and plastic.

15. An apparatus according to claim 8, wherein an innermost periphery of the data region is separated by 4.0 to 4.7 mm from a center.
